(19) United States
(12) Patent Application Publication
(10) Pub. No.: US 2012/0034430 A1
(43) Pub. Date: Feb. 9, 2012

(54) SANITARY TISSUE PRODUCTS COMPRISING A SURFACE PATTERN AND METHODS FOR MAKING SAME

(76) Inventors: Naomi Ruth Nelson, Cincinnati, OH (US); Jason Merrill Jones, Oregonia, OH (US); Rebecca Kathleen Pagels, Leesburg, GA (US); Monica Ho-Kleinwaechter, Loveland, OH (US); Julie Spaeth Lovelace, Liberty Township, OH (US); André Mellin, Amberley Village, OH (US); John Allen Manifold, Milan, IN (US); Frederick Scott Britton, Cincinnati, OH (US); Jeffrey Glen Sheehan, Cincinnati, OH (US); Nicholas August Vitucci, Cincinnati, OH (US); Alexander Paul Weber, Cincinnati, OH (US)

(21) Appl. No.: 13/205,684

(22) Filed: Aug. 9, 2011

Related U.S. Application Data
(60) Provisional application No. 61/438,387, filed on Feb. 1, 2011.
(60) Provisional application No. 61/371,855, filed on Aug. 9, 2010.

(51) Int. Cl. B32B 3/00

(52) U.S. Cl. 428/195.1

(57) ABSTRACT

Sanitary tissue products having a surface having a surface pattern and more particularly to sanitary tissue products having a surface having a surface pattern employing a first pattern overlaying a second pattern and methods for making same are provided.

### CROSS REFERENCE TO RELATED APPLICATION

This application claims the benefit of U.S. Provisional Application No. 61/438,387, filed Feb. 1, 2011, and U.S. Provisional Application No. 61/371,855, filed Aug. 9, 2010.

### FIELD OF THE INVENTION

The present invention relates to sanitary tissue products comprising a surface comprising a surface pattern and more particularly to sanitary tissue products comprising a surface comprising a surface pattern employing a first pattern overlaying a second pattern and methods for making same.

### BACKGROUND OF THE INVENTION

Sanitary tissue products comprising surfaces comprising surface patterns are known in the art. For example, embossed and/or wet-molded sanitary tissue products that comprise a surface comprising a surface pattern are known in the art. Surface patterns have been used for aesthetic reasons and for providing consumers with a perception about a characteristic or property of the sanitary tissue products.

Known surface patterns for sanitary tissue products include surface patterns that impart a woven appearance to the surface by associating discrete elements to form the appearance of a woven structure as shown in FIG. 1. Such surface patterns utilize similar if not identical elements that are arranged to provide the woven appearance. In addition, known surface patterns also comprise grid-like networks to impart an appearance such as a net as shown in FIG. 2. Further, known surface patterns also comprise wavy lines and dots as shown in FIG. 3. Lastly, known surface patterns include discrete elements that impart an image, such as a flower, butterfly, or geometric shape, to the surface as shown in FIG. 4. None of such known surface patterns comprise a first pattern that overlays a second pattern.

Consumers of sanitary tissue products, such as bath tissue, paper towels and/or facial tissue, continue to desire surface patterns on their sanitary tissue products that provide or are perceived by consumers to provide improved cleaning over known surface patterns on sanitary tissue products.

Accordingly, there is a need for a sanitary tissue product comprising a novel surface pattern, for example a surface pattern that provides consumers with a perception of improved cleaning compared to known surface patterns.

### SUMMARY OF THE INVENTION

The present invention fulfills the needs described above by providing a sanitary tissue product comprising a novel surface pattern, for example a surface pattern that comprises a first pattern that overlays a second pattern.

In one example of the present invention, a sanitary tissue product having a surface that comprises a surface pattern comprising a filamentary pattern overlaying a filamentary line pattern, is provided

In another example of the present invention, a sanitary tissue product having a surface that comprises a surface pattern comprising a filamentary pattern overlaying a filamentary line pattern and a discrete motif pattern overlaying one or more of the filamentary and filamentary line patterns, is provided.

In another example of the present invention, a sanitary tissue product comprising a surface comprising a surface pattern having a continuous element that extends across the surface in a first direction and a discrete element that extends across the surface in a second direction, wherein the second direction intersects the first direction, is provided.

In another example of the present invention, a patterned sanitary tissue product comprising a surface having a surface pattern, wherein the surface pattern comprises a first region comprising a plurality of parallel or substantially parallel straight line segments spaced apart from one another by at least 0.5 mm and a second region exhibiting a surface area of greater than 50 mm², wherein the surface area is void of the straight line segments, is provided.

In yet another example of the present invention, a method for making a sanitary tissue product according to the present invention is provided.

In still another example of the present invention, a method for making a patterned sanitary tissue product, the method comprising the step of imparting a pattern comprising a first region comprising a plurality of parallel or substantially parallel straight line segments spaced apart from one another by at least 0.5 mm and a second region exhibiting a surface area of greater than 50 mm², wherein the surface area is void of the straight line segments to a surface of a sanitary tissue product.

The present invention provides sanitary tissue products comprising a novel surface pattern and methods for making such sanitary tissue products.

### BRIEF DESCRIPTION OF THE DRAWINGS

FIG. 1 is a top plan view of a prior art surface pattern for a sanitary tissue product;

FIG. 2 is a top plan view of another prior art surface pattern for a sanitary tissue product;

FIG. 3 is a top plan view of another prior art surface pattern for a sanitary tissue product;

FIG. 4 is a top plan view of another prior art surface pattern for a sanitary tissue product;

FIG. 5A is a schematic representation of an example of a filamentary line pattern according to the present invention;

FIG. 5B is a schematic representation of another example of a filamentary line pattern according to the present invention;

FIG. 5C is a schematic representation of another example of a filamentary line pattern according to the present invention;

FIG. 6A is a schematic representation of an example of a filamentary pattern according to the present invention;

FIG. 6B is a schematic representation of another example of a filamentary pattern according to the present invention;

FIG. 6C is a schematic representation of another example of a filamentary pattern according to the present invention;

FIG. 7 is a top plan view of an example of a sanitary tissue product comprising a surface pattern comprising a filamentary pattern and a filamentary line pattern according to the present invention;

FIG. 8 is a top plan view of a portion of the surface pattern of FIG. 7;

FIG. 9 is a top plan view of the filamentary pattern of FIG. 7;

FIG. 10 is a top plan view of the filamentary line pattern of FIG. 7;

FIG. 11 is a top plan view of an example of a filamentary line pattern according to the present invention;

FIG. 12 is a top plan view of another example of a sanitary tissue product comprising a surface pattern comprising a filamentary pattern and a filamentary line pattern according to the present invention;

FIG. 13A is a MikroCAD graph of a sanitary tissue product comprising a filamentary pattern;

FIG. 13B is a MikroCAD graph of a sanitary tissue product comprising a filamentary line pattern; and

FIG. 14 is a top plan view of another example of a sanitary tissue product comprising a surface pattern comprising a filamentary pattern, a filamentary line pattern, and a discrete motif pattern according to the present invention.

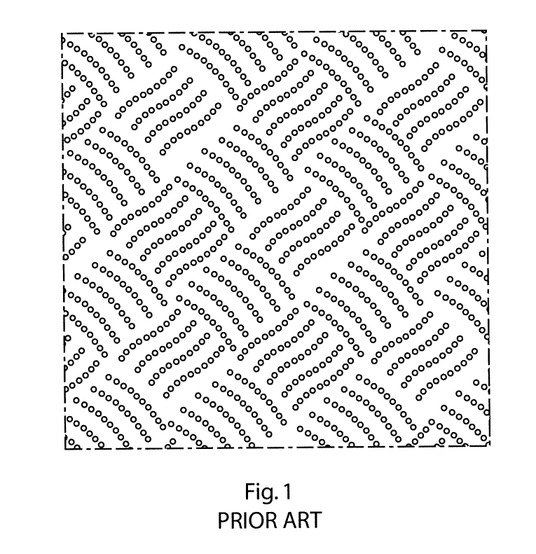

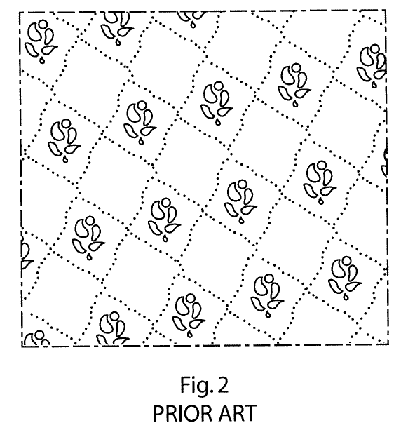

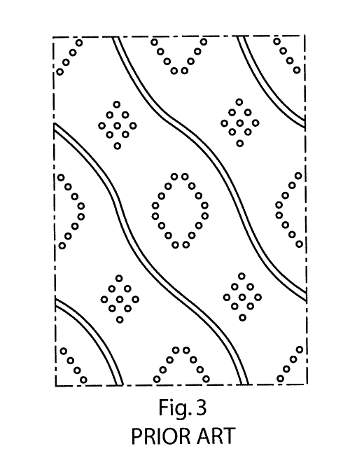

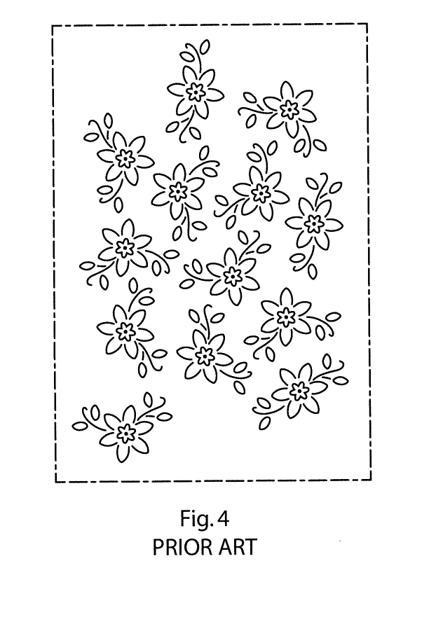

### DETAILED DESCRIPTION OF THE INVENTION

### Definitions

“Sanitary tissue product” as used herein means a soft, low density (i.e. <about 0.15 g/cm³ measured at 95 g/in²) sanitary tissue product useful as a wiping implement for post-urinary and post-bowel movement cleaning (toilet tissue), for otorhinolaryngological discharges (facial tissue), multi-functional absorbent and cleaning uses (absorbent towels) and wet and dry wipes. The sanitary tissue product may be convolutedly wound upon itself about a core or without a core to form a sanitary tissue product roll. Alternatively, the sanitary tissue product may be in the form of discrete sheets.

The sanitary tissue products and/or fibrous structures of the present invention may exhibit a basis weight of greater than 15 g/m² (9.2 lbs/3000 ft²) to about 120 g/m² (73.8 lbs/3000 ft²) and/or from about 15 g/m² (9.2 lbs/3000 ft²) to about 110 g/m² (67.7 lbs/3000 ft²) and/or from about 20 g/m² (12.3 lbs/3000 ft²) to about 100 g/m² (61.5 lbs/3000 ft²) and/or from about 30 (18.5 lbs/3000 ft²) to 90 g/m² (55.4 lbs/3000 ft²). In addition, the sanitary tissue products and/or fibrous structures of the present invention may exhibit a basis weight between about 40 g/m² (24.6 lbs/3000 ft²) to about 120 g/m² (73.8 lbs/3000 ft²) and/or from about 50 g/m² (30.8 lbs/3000 ft²) to about 110 g/m² (67.7 lbs/3000 ft²) and/or from about 55 g/m² (33.8 lbs/3000 ft²) to about 105 g/m² (64.6 lbs/3000 ft²) and/or from about 60 (36.9 lbs/3000 ft²) to 100 g/m² (61.5 lbs/3000 ft²).

The sanitary tissue products of the present invention may exhibit a density (measured at 95 g/in²) of less than about 0.60 g/cm³ and/or less than about 0.30 g/cm³ and/or less than about 0.20 g/cm³ and/or less than about 0.10 g/cm³ and/or less than about 0.07 g/cm³ and/or less than about 0.05 g/cm³ and/or from about 0.01 g/cm³ to about 0.20 g/cm³ and/or from about 0.02 g/cm³ to about 0.10 g/cm³.

The sanitary tissue products of the present invention may be in the foam of sanitary tissue product rolls. Such sanitary tissue product rolls may comprise a plurality of connected, but perforated sheets of fibrous structure, that are separably dispensable from adjacent sheets.

The sanitary tissue products of the present invention may comprise additives such as softening agents such as silicones and quaternary ammonium compounds, temporary wet strength agents, permanent wet strength agents, bulk softening agents, lotions, silicones, wetting agents, latexes, especially surface-pattern-applied latexes, dry strength agents such as carboxymethylcellulose and starch, and other types of additives suitable for inclusion in and/or on sanitary tissue products.

“Fibrous structure” as used herein means a structure that comprises one or more filaments and/or fibers. In one example, a fibrous structure according to the present invention means an orderly arrangement of filaments and/or fibers within a structure in order to perform a function. Non-limiting examples of fibrous structures of the present invention include paper, fabrics (including woven, knitted, and non-woven), and absorbent pads (for example for diapers or feminine hygiene products).

Non-limiting examples of processes for making fibrous structures include known wet-laid papermaking processes, which includes rush transfer and/or fabric creping and/or wet-micro contraction and/or wet pressing papermaking processes and air-laid papermaking processes. Such processes typically include steps of preparing a fiber composition in the form of a suspension in a medium, either wet, more specifically aqueous medium, or dry, more specifically gaseous, i.e. with air as medium. The aqueous medium used for wet-laid processes is oftentimes referred to as a fiber slurry. The fibrous slurry is then used to deposit a plurality of fibers onto a forming wire or belt such that an embryonic fibrous structure is formed, after which drying and/or bonding the fibers together results in a fibrous structure. Further processing the fibrous structure may be carried out such that a finished fibrous structure is formed. For example, in typical papermaking processes, the finished fibrous structure is the fibrous structure that is wound on the reel at the end of papermaking, and may subsequently be converted into a finished product, e.g. a sanitary tissue product.

The fibrous structures of the present invention may be homogeneous or may be layered. If layered, the fibrous structures may comprise at least two and/or at least three and/or at least four and/or at least five layers.

The fibrous structures of the present invention may be co-formed fibrous structures.

“Co-formed fibrous structure” as used herein means that the fibrous structure comprises a mixture of at least two different materials wherein at least one of the materials comprises a filament, such as a polypropylene filament, and at least one other material, different from the first material, comprises a solid additive, such as a fiber and/or a particulate. In one example, a co-formed fibrous structure comprises solid additives, such as fibers, such as wood pulp fibers, and filaments, such as polypropylene filaments.

“Solid additive” as used herein means a fiber and/or a particulate.

“Particulate” as used herein means a granular substance or powder.

“Fiber” and/or “Filament” as used herein means an elongate particulate having an apparent length greatly exceeding its apparent width, i.e. a length to diameter ratio of at least about 10. In one example, a “fiber” is an elongate particulate as described above that exhibits a length of less than 5.08 cm (2 in.) and a “filament” is an elongate particulate as described above that exhibits a length of greater than or equal to 5.08 cm (2 in.).

Fibers are typically considered discontinuous in nature. Non-limiting examples of fibers include wood pulp fibers and synthetic staple fibers such as polyester fibers.

Filaments are typically considered continuous or substantially continuous in nature. Filaments are relatively longer than fibers. Non-limiting examples of filaments include meltblown and/or spunbond filaments. Non-limiting examples of materials that can be spun into filaments include natural polymers, such as starch, starch derivatives, cellulose and cellulose derivatives, hemicellulose, hemicellulose derivatives, and synthetic polymers including, but not limited to polyvinyl alcohol filaments and/or polyvinyl alcohol derivative filaments, and thermoplastic polymer filaments, such as polyesters, nylons, polyolefins such as polypropylene filaments, polyethylene filaments, and biodegradable or compostable thermoplastic fibers such as polylactic acid filaments, polyhydroxyalkanoate filaments and polycaprolactone filaments. The filaments may be monocomponent or multicomponent, such as bicomponent filaments.

In one example of the present invention, “fiber” refers to papermaking fibers. Papermaking fibers useful in the present invention include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified web. U.S. Pat. No. 4,300,981 and U.S. Pat. No. 3,994,771 are incorporated herein by reference for the purpose of disclosing layering of hardwood and softwood fibers. Also applicable to the present invention are fibers derived from recycled paper, which may contain any or all of the above categories as well as other non-fibrous materials such as fillers and adhesives used to facilitate the original papermaking. Non-limiting examples of suitable hardwood pulp fibers include eucalyptus and acacia. Non-limiting examples of suitable softwood pulp fibers include Southern Softwood Kraft (SSK) and Northern Softwood Kraft (NSK).

In addition to the various wood pulp fibers, other cellulosic fibers such as cotton linters, rayon, lyocell and bagasse can be used in this invention. Other sources of cellulose in the form of fibers or capable of being spun into fibers include grasses and grain sources.

In addition, trichomes such as from “lamb's ear” plants and seed hairs can also be utilized in the fibrous structures of the present invention.

“Weight average molecular weight” as used herein means the weight average molecular weight as determined using gel permeation chromatography according to the protocol found in Colloids and Surfaces A. Physico Chemical & Engineering Aspects, Vol. 162, 2000, pg. 107-121.

“Basis Weight” as used herein is the weight per unit area of a sample reported in lbs/3000 ft² or g/m² and is measured according to the Basis Weight Test Method described herein.

“Caliper” as used herein means the macroscopic thickness of a fibrous structure. Caliper is measured according to the Caliper Test Method described herein.

“Bulk” as used herein is calculated as the quotient of the Caliper, expressed in microns, divided by the Basis Weight, expressed in grams per square meter. The resulting Bulk is expressed as cubic centimeters per gram. For the products of this invention, Bulks can be greater than about 3 cm³/g and/or greater than about 6 cm³/g and/or greater than about 9 cm³/g and/or greater than about 10.5 cm³/g up to about 30 cm³/g and/or up to about 20 cm³/g . The products of this invention derive the Bulks referred to above from the basesheet, which is the sheet produced by the tissue machine without post treatments such as embossing. Nevertheless, the basesheets of this invention can be embossed to produce even greater bulk or aesthetics, if desired, or they can remain unembossed. In addition, the basesheets of this invention can be calendered to improve smoothness or decrease the Bulk if desired or necessary to meet existing product specifications.

“Density” as used herein is calculated as the quotient of the Basis Weight expressed in grams per square meter divided by the Caliper expressed in microns.

“Machine Direction” or “MD” as used herein means the direction parallel to the flow of the fibrous structure through the fibrous structure making machine and/or sanitary tissue product manufacturing equipment.

“Cross Machine Direction” or “CD” as used herein means the direction parallel to the width of the fibrous structure making machine and/or sanitary tissue product manufacturing equipment and perpendicular to the machine direction.

“Ply” as used herein means an individual, integral fibrous structure.

“Plies” as used herein means two or more individual, integral fibrous structures disposed in a substantially contiguous, face-to-face relationship with one another, forming a multi-ply sanitary tissue product. It is also contemplated that an individual, integral fibrous structure can effectively form a multi-ply sanitary tissue product, for example, by being folded on itself.

“Surface pattern” with respect to a sanitary tissue product in accordance with the present invention means herein a pattern that is present on at least one surface of the sanitary tissue product. The surface pattern may be a textured surface pattern such that the surface of the sanitary tissue product comprises protrusions and/or depressions as part of the surface pattern. For example, the surface pattern may comprise embossments. The surface pattern may be a non-textured surface pattern such that the surface of the sanitary tissue product does not comprise protrusions and/or depressions as part of the surface pattern. For example, the surface pattern may be printed on a surface of the sanitary tissue product.

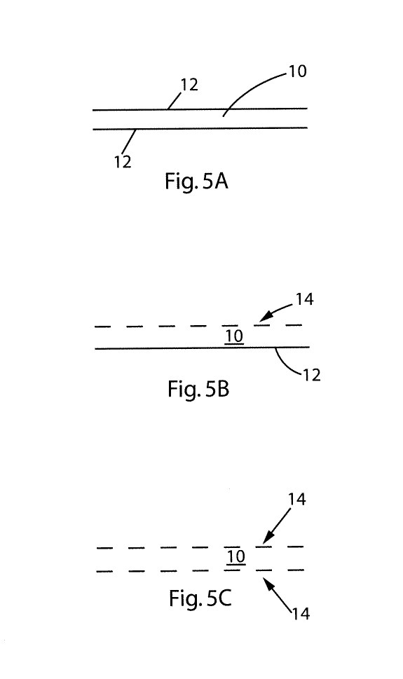

“Filamentary line pattern” as used herein means an image and/or actual area of a midline of a strip under a homeomorphism of the strip onto itself In one example, a filamentary line pattern is the area between two parallel or substantially parallel lines. FIG. 5A shows an example of a filamentary line pattern 10 formed from two continuous lines 12 according to the present invention. FIG. 5B illustrates an example of a filamentary line pattern 10 formed from a continuous line 12 and a broken line 14 according to the present invention. FIG. 5C shows an example of a filamentary line pattern 10 formed from two broken lines 14 according to the present invention. Two or more filamentary line patterns within the surface pattern may exhibit one or more common dimensions and/or one or more different dimensions.

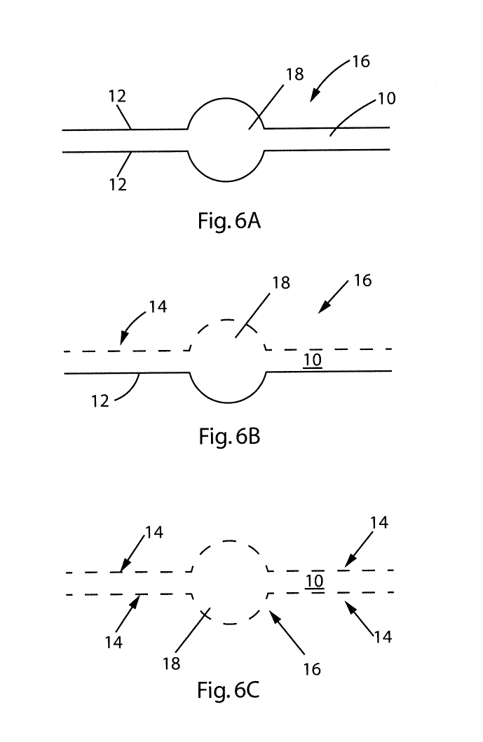

“Filamentary pattern” as used herein means a filamentary line pattern that comprises at least one motif. “Motif” as used herein means a distinctive and oftentimes recurring shape. The motif may be any shape and/or size. Non-limiting examples of suitable shapes include circles, ovals, rectangles, squares, triangles, portions of any of such shapes and derivatives of any such shapes. In one example, a filamentary pattern is the area between two parallel or substantially parallel lines that includes at least one shape. FIG. 6A shows an example of a filamentary pattern 16, which is a filamentary line pattern 10 formed from two continuous lines 12, wherein the filamentary line pattern 10 comprises a motif 18, according to the present invention. FIG. 6B shows an example of a filamentary pattern 16, which is a filamentary line pattern 10 formed from a continuous line 12 and a broken line 14, wherein the filamentary line pattern 10 comprises a motif 18, according to the present invention. FIG. 6C shows an example of a filamentary pattern 16, which is a filamentary line pattern 10 formed from two broken lines 14, wherein the filamentary line pattern 10 comprises a motif 18, according to the present invention. Two or more filamentary patterns within the surface pattern may exhibit one or more common dimensions and/or one or more different dimensions.

“Overlaying” or “overlays” as used herein means one pattern covers one or more portions of another pattern (but not the entirety of the pattern) such that the covered portions are not visible to a consumer.

“Symmetry axis” as used herein means a line that divides a two-dimensional object into identical shapes.

“Spaced apart from one another center-to-center” as used herein means the distance between two objects from one objects symmetry axis to the other objects symmetry axis.

“Minimum width” as used herein with respect to a filamentary pattern and/or filamentary line pattern means the minimum width of the pattern as measured perpendicular to the patterns' symmetry axis from one continuous line or broken line segment to the other continuous line or broken line segment of the filamentary pattern and/or filamentary line pattern.

“Continuous element” as used herein means a shape that extends entirely or substantially entirely across a surface pattern on a sanitary tissue product.

“Discrete element” as used herein means a shape that extends across a portion of a surface pattern on a sanitary tissue product to an edge of a continuous element.

“Direction” as used herein means the direction of an axis of symmetry for a filamentary pattern and/or filamentary line pattern.

“Angle” as used herein means the angle formed by an axis of symmetry for a filamentary pattern and/or filamentary line pattern with the machine direction or cross-machine direction of the sanitary tissue product and/or with an axis of symmetry of another filamentary pattern and/or filamentary line pattern.

“Embossed” as used herein with respect to a sanitary tissue product means a sanitary tissue product that has been subjected to a process which converts a smooth surfaced fibrous structure to a decorative surface by replicating a design on one or more emboss rolls, which form a nip through which the fibrous structure passes. Embossed does not include creping, microcreping, printing or other processes that may impart a texture and/or decorative pattern to a fibrous structure.

“Line embossment” as used herein means an embossment that comprises a continuous line that has an aspect ratio of greater than 1.5:1 and/or greater than 1.75:1 and/or greater than 2:1 and/or greater than 5:1. In one example, the line embossment exhibits a length of at least 2 mm and/or at least 4 mm and/or at least 6 mm and/or at least 1 cm to about 10.16 cm and/or to about 8 cm and/or to about 6 cm and/or to about 4 cm.

The continuous lines and/or broken lines of the filamentary pattern and/or filamentary line pattern of the present invention may be formed by a line embossment or line embossments. In one example, the continuous lines and/or broken lines of the filamentary pattern and/or filamentary line pattern of the present invention may be formed by lines that are formed by wet molding and/or a through-air-drying fabric and/or an imprinted through-air-drying fabric.

“Dot embossment” as used herein means an embossment that exhibits an aspect ratio of about 1:1. Non-limiting examples of dot embossments are embossments that are shaped like circles, squares, rectangles (dashes) and/or triangles. A plurality of dot embossments may form a broken line of a filamentary pattern and/or filamentary line pattern.

“Water-resistant” as it refers to a surface pattern or part thereof means that a pattern retains its structure and/or integrity after being saturated by water and the pattern is still visible to a consumer. In one example, the continuous lines and/or broken lines of the filamentary pattern and/or filamentary line pattern may be water-resistant.

### Fibrous Structure

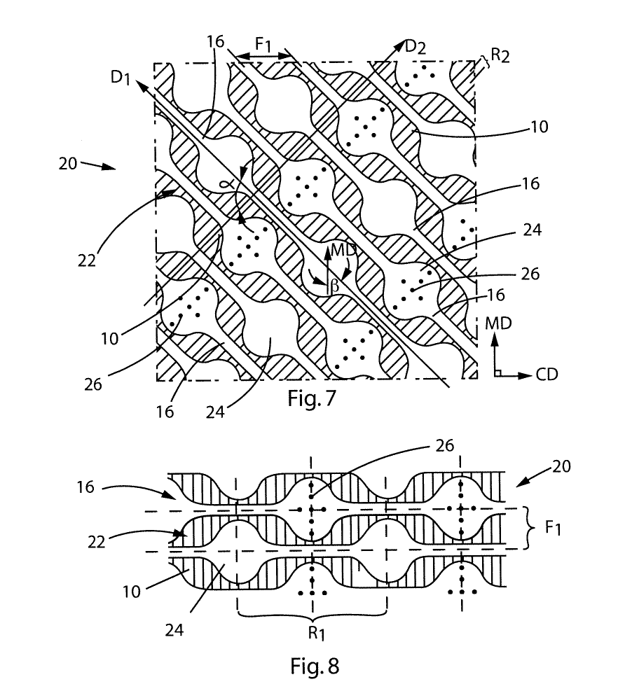

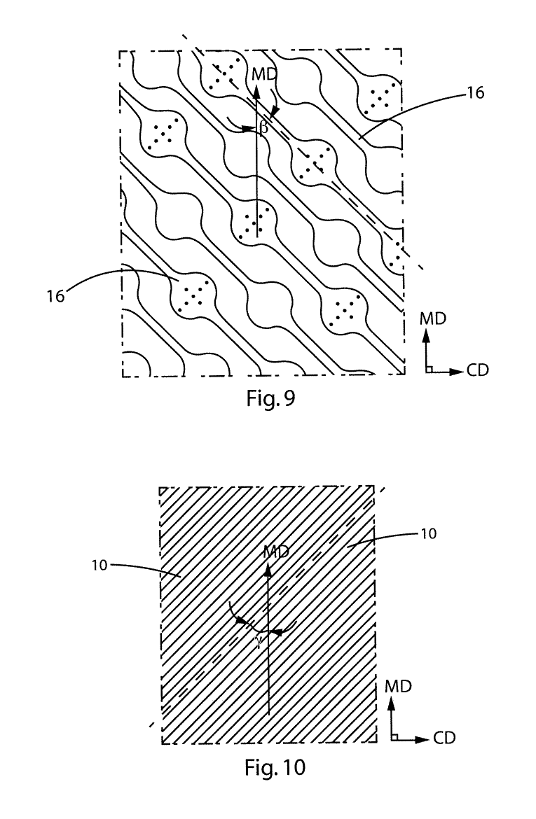

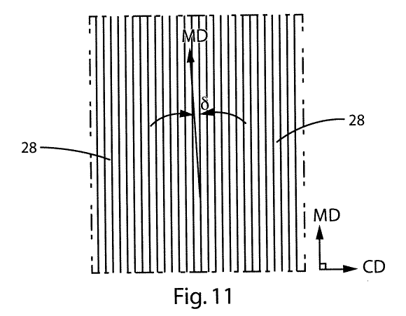

As shown in FIGS. 7 and 8, an example of a fibrous structure 20 of the present invention comprises a surface 22 exhibiting a machine direction and a cross machine direction. The surface 22 having a surface pattern comprising a filamentary pattern 16 and a filamentary line pattern 10. As shown in FIGS. 7 and 9, two or more, for example a plurality of filamentary patterns 16 may folio part of the surface pattern on the fibrous structure 20. As shown in FIGS. 7 and 10, two or more, for example a plurality of filamentary line patterns 10 may form part of the surface pattern on the fibrous structure 20. As shown in FIGS. 7 and 8, the filamentary pattern 16 overlays the filamentary line pattern 10.

As shown in FIGS. 7 and 9, the filamentary pattern 16 may comprise a motif 24 comprising a dot 26. The motif 24 may comprise a plurality of dots 26. The plurality of dots 26 may create a dot pattern. As shown in FIG. 8, two or more motifs 24 may be spaced apart from one another center-to-center by at least 1.5 cm and/or at least 1.75 cm and/or at least 2 cm and/or at least 2.25 cm and/or at least 2.5 cm and/or at least 3 cm and/or at least 5 cm as shown by R₁.

When the surface pattern comprises two or more filamentary patterns 16 as shown in FIGS. 7-9, at least one of the two or more filamentary patterns 16 may comprise a motif 24 comprising a dot 26.

In one example, the surface pattern comprises two or more filamentary patterns 16 wherein at least two of the two or more filamentary patterns 16 are spaced apart from one another center-to-center by at least 1 cm and/or at least 1.5 cm and/or at least 2 cm and/or at least 2.25 cm and/or at least 2.5 cm and/or at least 3 cm and/or at least 5 cm as shown by F₁ in FIGS. 7 and 8.

One or more filamentary patterns and/or filamentary line patterns of the present invention may exhibit a minimum width of at least 40 mils and/or at least 50 mils and/or at least 60 mils and/or to about 220 mils and/or to about 200 mils and/or to about 170 and/or to about 150 mils and/or to about 100 mils.

When the surface pattern comprises two or more filamentary line patterns 10 as shown in FIGS. 7, 8, and 10, at least two of the two or more filamentary line patterns 10 are spaced apart from one another center-to-center by at least 2 mm and/or at least 3 mm and/or at least 4 mm and/or at least 5 mm and/or at least 7 mm as shown by R₂ in FIG. 7.

In one example, one or more continuous lines and/or broken line segments forming a filamentary pattern and/or filamentary line pattern may exhibit a minimum width of at least 10 mils and/or at least 20 mils and/or at least 30 mils and/or to about 100 mils and/or to about 80 mils and/or to about 60 mils.

As shown in FIG. 7, the filamentary pattern 16 overlays the filamentary line pattern 10 at an angle α of from about 20° to about 160° and/or from about 30° to about 150° and/or from about 40° to about 140° and/or from about 45° to about 135° and/or from about 50° to about 130° and/or from about 75° to about 105° and/or about 90°.

As shown in FIGS. 7 and 9, the filamentary pattern 16 based on its symmetry axis (shown in solid line in FIG. 7 and in dotted line in FIG. 9) may be oriented on the surface 22 of the sanitary tissue product 20 at an angle β of from about 20° to about 160° and/or from about 30° to about 150° and/or from about 40° to about 140° and/or from about 45° to about 135° and/or from about 50° to about 130° and/or from about 75° to about 105° and/or about 90° relative to the machine direction. In one example, the filamentary pattern 16 is oriented on the surface 22 of the sanitary tissue product 20 at an angle β of from about 45° relative to the machine direction.

As shown in FIG. 10, the filamentary line pattern 10 based on its symmetry axis (shown in dotted line) may be oriented on the surface 22 of the sanitary tissue product 20 at an angle γ of from about 20° to about 160° and/or from about 30° to about 150° and/or from about 40° to about 140° and/or from about 45° to about 135° and/or from about 50° to about 130° and/or from about 75° to about 105° and/or about 90° relative to the machine direction. In one example, the filamentary line pattern 10 is oriented on the surface 22 of the sanitary tissue product 20 at an angle γ of from about 45° relative to the machine direction.

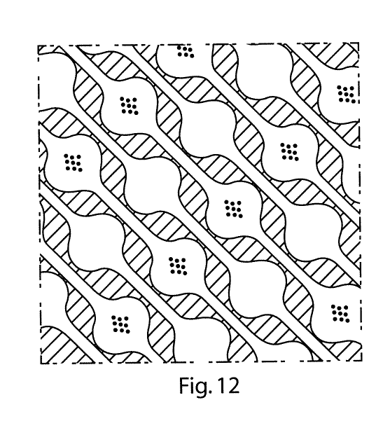

In one example, the surface pattern may comprise a second filamentary line pattern 28, as shown in FIG. 11. The second filamentary line pattern 28 may be present in the filamentary pattern 16 and/or in the filamentary line pattern 10. For example, the second filamentary line pattern 28 may be visible by a consumer in the filamentary pattern 16 and/or the filamentary line pattern 10.

The surface pattern may comprise two or more second filamentary line patterns 28. When the surface pattern comprises two or more second filamentary line patterns 28, at least two of the two or more filamentary line patterns 28 are spaced apart from one another center-to-center by at least 1 mm and/or at least 1.5 mm and/or at least 2 mm and/or at least 2.5 mm and/or at least 3 mm and/or at least 5 mm.

The second filamentary line pattern 28 may be formed by two continuous lines and/or broken lines and/or a combination of continuous and broken lines.

In one example, one or more continuous lines and/or broken line segments forming the second filamentary line pattern 28 may exhibit a minimum width of at least 3 mils and/or 5 mils and/or at least 7 mils and/or at least 10 mils and/or at least 15 mils and/or to about 50 mils and/or to about 40 mils and/or to about 30 mils and/or to about 20 mils.

The second filamentary line pattern 28 may exhibit a minimum width of at least 0.5 mils and/or at least 0.7 mils and/or at least 1 mil and/or at least 1.25 mils and/or at least 1.5 mils to about 5 mils and/or to about 4 mils and/or to about 3 mils.

In one example, the second filamentary line pattern 28 may intersect the filamentary pattern 16 at an angle of from about 20° to about 160° and/or from about 30° to about 150° and/or from about 40° to about 140° and/or from about 45° to about 135° and/or from about 50° to about 130° and/or from about 75° to about 105° and/or about 90°.

In another example, as shown in FIG. 11, the second filamentary line pattern 28 may be oriented on the surface of the sanitary tissue product at an angle δ of from about 0° to about 15° relative to the machine direction.

In another example, as shown in FIG. 7, the fibrous structure 20 of the present invention comprises a surface 22 comprising a surface pattern having a continuous element, such as a filamentary pattern 16 and a discrete element, such as a filamentary line pattern 10. The continuous element extends across the surface 22 in a first direction D₁. The discrete element extends across the surface 22 in a second direction D₂. The second direction D₂ intersects the first direction D₁.

In one example, the second direction D₂ intersects the first direction D₁ at an angle α of from about 20° to about 160° and/or from about 30° to about 150° and/or from about 40° to about 140° and/or from about 45° to about 135° and/or from about 50° to about 130° and/or from about 75° to about 105° and/or about 90°.

In one example, the continuous element extends across the entire surface of the fibrous structure. In another example, the continuous element extends across substantially the entire surface of the fibrous structure. In still another example, the continuous element extends across greater than 50% and/or greater than 75% of the surface of the fibrous structure.

In one example, the continuous element may comprise a discrete sub-element. The discrete sub-element may comprise an embossment. In one example, the embossment comprises a dot embossment. In another example, the embossment comprises a line element embossment.

In another example of the present invention, the surface pattern of the fibrous structure 20 may comprise a third element (not shown), for example a second filamentary line pattern 28, that extends across the surface 22 in a third direction different from the first and second directions D₁, D₂. In one example, the third element comprises one or more continuous elements. In another example, the third element may comprise one or more discrete elements.

In yet another example, the third element may be present in the continuous and/or discrete elements corresponding to the first and second directions D₁ and D₂. For example, the third element may be visible by a consumer in one or more of the continuous and discrete elements.

The surface pattern may be an emboss pattern, imparted by passing a fibrous structure through an embossing nip comprising at least one patterned embossing roll patterned to impart a surface pattern according to the present invention, and/or a water-resistant pattern (i.e., wet-molded pattern), such as a patterned through-air-drying belt that is patterned to impart a surface pattern according to the present invention, and/or a rush transfer or fabric creped or wet pressed imparted surface pattern or portions thereof, which imparts texture to the sanitary tissue product typically during the sanitary tissue product-making process.

In yet another example of the present invention. the sanitary tissue product may comprise a patterned sanitary tissue product comprising a surface having a surface pattern, wherein the surface pattern comprises a first region comprising a plurality of parallel or substantially parallel straight line segments spaced apart from one another by at least 0.5 mm and/or at least 0.7 mm and/or at least 1 mm and a second region exhibiting a surface area of greater than 50 mm², wherein the surface area is void of the straight line segments. The straight line segments are spaced apart from one another center-to-center by at least 1 mm and/or at least 2 mm and/or at least 3 mm and/or less than 40 mm and/or less than 30 mm and/or less than 20 mm and/or less than 10 mm.

In one example, at least one of the straight line segments exhibits a length of greater than 5 mm and/or greater than 7 mm. The straight line segments may be recessed into the surface of the patterned sanitary tissue product relative to the second region.

In another example, the second region of the patterned sanitary tissue product may comprise at least one border that is defined by a line. The second region may exhibit a surface area of greater than 75 mm² and/or greater than 100 mm² and/or greater than 200 mm² and/or greater than 300 mm².

The patterned sanitary tissue product may further comprise a third region that exhibits a surface area of greater than 50 mm² and/or greater than 75 mm² and/or greater than 100 mm². The third regions may comprise one or more dots and is void of the straight line segments.

The third region, when present may exhibit a surface area that is equal to or less than the surface area of the second region.

FIG. 12 shows an example of another sanitary tissue product comprising a surface pattern according to the present invention.

In one example, the surface of the sanitary tissue product comprises a surface pattern that is textured. For example, a surface pattern that comprises textured ribs and/or a scrubby texture for removing, helping to remove and/or dislodge and/or being perceived as removing and/or dislodging soil, such as bowel movement soil and/or other solid and/or liquid excrements from a consumer's skin, during a wiping process by a consumer using the sanitary tissue product. In another example, the surface pattern may comprise a textured region (for example a “cleaning zone”) such as textured ribs as described above and a non-textured region (for example an “absorbent zone”) for collecting, helping to collect and/or being perceived as collecting soil, such as bowel movement soil and/or other solid and/or liquid excrements from a consumer's skin, during a wiping process by a consumer using the sanitary tissue product. In another example, a portion of the non-textured region may be or may be perceived by consumers as being anchored and/or bonded to another ply of sanitary tissue product. In even another example, the surface of the sanitary tissue product of the present invention may comprise different elevations, especially with respect to the textured and non-textured regions. For example, the non-textured region may protrude from the surface of the sanitary tissue product greater than the textured region. In other words, the filamentary pattern of the surface pattern may protrude from the surface of the sanitary tissue product greater than the filamentary line pattern. This elevation difference may be actual or perceived by consumers of the sanitary tissue product.

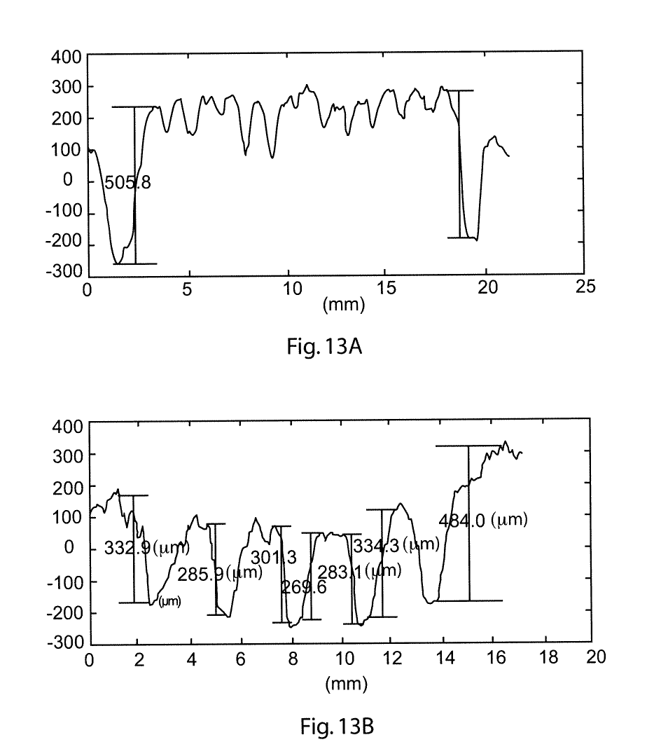

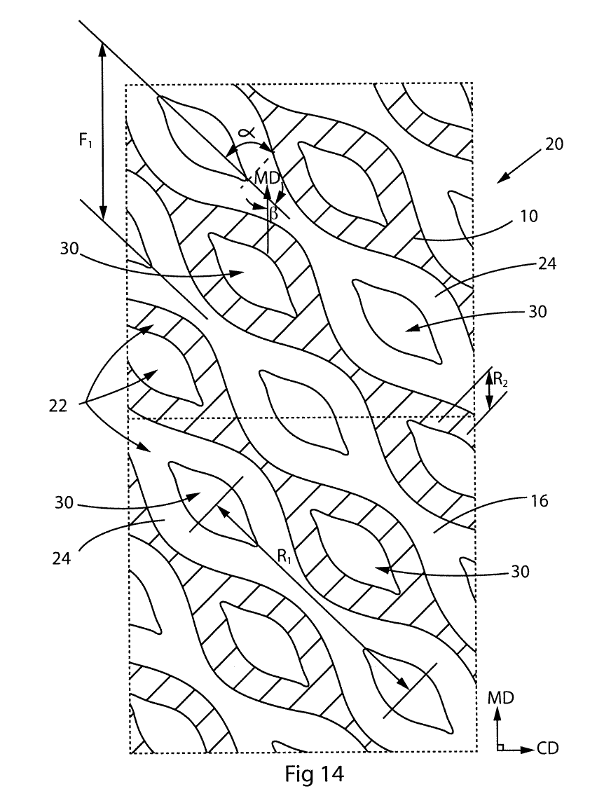

In one example as shown in FIG. 13A, a sanitary tissue product of the present invention comprises a surface pattern comprising a filamentary pattern that exhibits a first elevation as measured according to the Elevation Test Method described herein. As shown in FIG. 13B, the sanitary tissue product of the present invention comprises a filamentary line pattern that exhibits a second elevation as measured according to the Elevation Test Method described herein. In another example, a sanitary tissue product of the present invention may exhibit an average elevation for a filamentary pattern of greater than 150 μm and/or greater than 150 μm to about 600 μm and/or greater than 250 μm to about 550 μm and/or to about 400 μm and an average elevation for a filamentary line pattern of greater than 25 μm and/or greater than 25 μm to about 550 μm and/or greater than 100 μm to about 400 μm and/or to about 310 μm as measured according to the Elevation Test Method described herein. In still another example, a sanitary tissue product according to the present invention comprises a surface pattern comprising a filamentary pattern and a filamentary line pattern wherein the ratio of average elevation of the filamentary pattern to the average elevation of the filamentary line pattern is greater than 1.1 and/or greater than 1.2 and/or greater than 1.3 and/or greater than 1.4 and/or greater than 1.5 and/or to about 3 and/or to about 2.5 and/or to about 2 as measured according to the Elevation Test Method described herein.

FIG. 14 illustrates another example of a fibrous structure 20 of the present invention comprising a surface 22 exhibiting a machine direction and a cross machine direction. The surface 22 having a surface pattern comprising a filamentary pattern 16, a filamentary line pattern 10 and a discrete motif pattern 30 (e.g., a pattern of discrete individual motifs). The discrete motif pattern 30 may be made up of discrete individual motifs 32 of one or more shapes. Non-limiting examples of shapes suitable for the discrete individual motifs 32 include circles, squares, diamond, ellipses, rectangles, triangles, other polygons, tear drops, As shown in FIG. 14, two or more, for example a plurality of filamentary patterns 16 may form part of the surface pattern on the fibrous structure 20. As shown in FIG. 14, two or more, for example a plurality of filamentary line patterns 10 may form part of the surface pattern on the fibrous structure 20. As shown in FIG. 14, the filamentary pattern 16 overlays the filamentary line pattern 10.

As shown in FIG. 14, the filamentary pattern 16 may comprise a motif 24, which may itself comprise one or more discrete individual motifs 32. Two or more of the motifs 24 may be spaced apart from one another center-to-center by at least 1.5 cm and/or at least 1.75 cm and/or at least 2 cm and/or at least 2.25 cm and/or at least 2.5 cm and/or at least 3 cm and/or at least 5 cm and/or at least 7 cm and/or at least 9 cm as shown by R₁ in FIG. 14.

When the surface pattern comprises two or more filamentary patterns 16 as shown in FIG. 14, at least one of the two or more filamentary patterns 16 may comprise a motif 24 comprising a discrete individual motif 32.

In one example, the surface pattern comprises two or more filamentary patterns 16 wherein at least two of the two or more filamentary patterns 16 are spaced apart from one another center-to-center by at least 1 cm and/or at least 1.5 cm and/or at least 2 cm and/or at least 2.25 cm and/or at least 2.5 cm and/or at least 3 cm and/or at least 5 cm as shown by F₁ in FIG. 14.

One or more filamentary patterns and/or filamentary line patterns of the present invention may exhibit a minimum width of at least 40 mils and/or at least 50 mils and/or at least 60 mils and/or to about 220 mils and/or to about 200 mils and/or to about 170 and/or to about 150 mils and/or to about 100 mils.

When the surface pattern comprises two or more filamentary line patterns 10 as shown in FIG. 14, at least two of the two or more filamentary line patterns 10 are spaced apart from one another center-to-center by at least 2 mm and/or at least 3 mm and/or at least 4 mm and/or at least 5 mm and/or at least 7 mm and/or at least 9 mm and/or at least 10 mm as shown by R₂ in FIG. 14.

In one example, one or more continuous lines and/or broken line segments forming a filamentary pattern and/or filamentary line pattern may exhibit a minimum width of at least 10 mils and/or at least 20 mils and/or at least 30 mils and/or to about 100 mils and/or to about 80 mils and/or to about 60 mils.

As shown in FIG. 14, the filamentary pattern 16 overlays the filamentary line pattern 10 at an angle α of from about 20° to about 160° and/or from about 30° to about 150° and/or from about 40° to about 140° and/or from about 45° to about 135° and/or from about 50° to about 130° and/or from about 75° to about 105° and/or about 90°.

As shown in FIG. 14, the filamentary pattern 16 based on its symmetry axis (shown in solid line in FIG. 14) may be oriented on the surface 22 of the sanitary tissue product 20 at an angle β of from about 20° to about 160° and/or from about 30° to about 150° and/or from about 40° to about 140° and/or from about 45° to about 135° and/or from about 50° to about 130° and/or from about 75° to about 105° and/or about 90° relative to the machine direction. In one example, the filamentary pattern 16 is oriented on the surface 22 of the sanitary tissue product 20 at an angle β of from about 45° relative to the machine direction.

The sanitary tissue products comprising a surface pattern of the present invention may be perceived by consumers of sanitary tissue products as being able to provide better cleaning of soil, especially bowel movement soil, compared to sanitary tissue products comprising surface patterns not within the scope of the present invention.

### Methods for Making Sanitary Tissue Products

The sanitary tissue products of the present invention may be made by any suitable process known in the art. The method may be a sanitary tissue product making process that uses a cylindrical dryer such as a Yankee (a Yankee-process) or it may be a Yankeeless process as is used to make substantially uniform density and/or uncreped sanitary tissue products.

The sanitary tissue product of the present invention may be made using a molding member. A “molding member” is a structural element that can be used as a support for an embryonic web comprising a plurality of cellulosic fibers and a plurality of synthetic fibers, as well as a forming unit to form, or “mold,” a desired microscopical geometry of the sanitary tissue product of the present invention. The molding member may comprise any element that has fluid-permeable areas and the ability to impart a microscopical three-dimensional pattern to the structure being produced thereon, and includes, without limitation, single-layer and multi-layer structures comprising a stationary plate, a belt, a woven fabric (including Jacquard-type and the like woven patterns), a band, and a roll. In one example, the molding member is a deflection member. The molding member may comprise a surface pattern according to the present invention that is imparted to the sanitary tissue product during the sanitary tissue product making process.

A “reinforcing element” is a desirable (but not necessary) element in some embodiments of the molding member, serving primarily to provide or facilitate integrity, stability, and durability of the molding member comprising, for example, a resinous material. The reinforcing element can be fluid-permeable or partially fluid-permeable, may have a variety of embodiments and weave patterns, and may comprise a variety of materials, such as, for example, a plurality of interwoven yarns (including Jacquard-type and the like woven patterns), a felt, a plastic, other suitable synthetic material, or any combination thereof.

In one example of a method for making a sanitary tissue product of the present invention, the method comprises the step of contacting an embryonic fibrous web with a deflection member (molding member) such that at least one portion of the embryonic fibrous web is deflected out-of-plane of another portion of the embryonic fibrous web. The phrase “out-of-plane” as used herein means that the sanitary tissue product comprises a protuberance, such as a dome, or a cavity that extends away from the plane of the sanitary tissue product. The molding member may comprise a through-air-drying fabric having its filaments arranged to produce linear elements within the sanitary tissue products of the present invention and/or the through-air-drying fabric or equivalent may comprise a resinous framework that defines deflection conduits that allow portions of the sanitary tissue product to deflect into the conduits thus forming linear elements within the sanitary tissue products of the present invention. In addition, a forming wire, such as a foraminous member may be arranged such that linear elements within the sanitary tissue products of the present invention are formed and/or like the through-air-drying fabric, the foraminous member may comprise a resinous framework that defines deflection conduits that allow portions of the sanitary tissue product to deflect into the conduits thus forming linear elements within the sanitary tissue products of the present invention.

In another example of a method for making a sanitary tissue product of the present invention, the method comprises the steps of:
(a) providing a fibrous furnish comprising fibers;
(b) depositing the fibrous furnish onto a foraminous member to form an embryonic fibrous web;
(c) associating the embryonic fibrous web with a deflection member comprising a surface pattern such that the surface pattern; and
(d) drying said embryonic fibrous web such that that the surface pattern is imparted to the dried sanitary tissue product.

In another example of a method for making a sanitary tissue product of the present invention, the method comprises the steps of:
(a) providing a fibrous structure; and
(b) imparting a surface pattern to the fibrous structure to produce the sanitary tissue product.

In another example, the step of imparting a surface pattern to a sanitary tissue product comprises contacting a molding member comprising a surface pattern with a sanitary tissue product such that the pattern is imparted to the sanitary tissue product. The molding member may be a patterned belt that comprises a surface pattern.

In another example, the step of imparting a surface pattern to a sanitary tissue product comprises passing a sanitary tissue product through an embossing nip formed by at least one embossing roll comprising a surface pattern such that the surface pattern is imparted to the sanitary tissue product.

### NON-LIMITING EXAMPLES

### Example 1

The following Example illustrates a non-limiting example for a preparation of a sanitary tissue product comprising a sanitary tissue product according to the present invention on a pilot-scale Fourdrinier sanitary tissue product making machine.

An aqueous slurry of eucalyptus (Aracruz Brazilian bleached hardwood kraft pulp) pulp fibers is prepared at about 3% fiber by weight using a conventional repulper, then transferred to the hardwood fiber stock chest. The eucalyptus fiber slurry of the hardwood stock chest is pumped through a stock pipe to a hardwood fan pump where the slurry consistency is reduced from about 3% by fiber weight to about 0.15% by fiber weight. The 0.15% eucalyptus slurry is then pumped and equally distributed in the top and bottom chambers of a multi-layered, three-chambered headbox of a Fourdrinier wet-laid papermaking machine.

Additionally, an aqueous slurry of NSK (Northern Softwood Kraft) pulp fibers is prepared at about 3% fiber by weight using a conventional repulper, then transferred to the softwood fiber stock chest. The NSK fiber slurry of the softwood stock chest is pumped through a stock pipe to be refined to a Canadian Standard Freeness (CSF) of about 630. The refined NSK fiber slurry is then directed to the NSK fan pump where the NSK slurry consistency is reduced from about 3% by fiber weight to about 0.15% by fiber weight. The 0.15% eucalyptus slurry is then directed and distributed to the center chamber of a multi-layered, three-chambered headbox of a Fourdrinier wet-laid papermaking machine.

The sanitary tissue product making machine has a layered headbox having a top chamber, a center chamber, and a bottom chamber where the chambers feed directly onto the forming wire. The eucalyptus fiber slurry of 0.15% consistency is directed to the top headbox chamber and bottom headbox chamber. The NSK fiber slurry is directed to the center headbox chamber. All three fiber layers are delivered simultaneously in superposed relation onto the Fourdrinier wire to form thereon a three-layer embryonic web, of which about 25% of the top side is made up of the eucalyptus fibers, about 25% is made of the eucalyptus fibers on the bottom side and about 50% is made up of the NSK fibers in the center. Dewatering occurs through the Fourdrinier wire and is assisted by a deflector and wire table vacuum boxes. The Fourdrinier wire is of an Asten Johnson 866A design. The speed of the Fourdrinier wire is about 750 feet per minute (fpm).

The embryonic wet web is transferred from the Fourdrinier wire, at a fiber consistency of about 15% at the point of transfer, to a patterned drying fabric. The speed of the patterned drying fabric is the same as the speed of the Fourdrinier wire. The drying fabric is designed to yield a pattern of low density pillow regions and high density knuckle regions. This drying fabric is formed by casting an impervious resin surface onto a fiber mesh supporting fabric. The supporting fabric is a 127×52 filament, dual layer mesh. The thickness of the resin cast is about 12 mils above the supporting fabric.

Further de-watering is accomplished by vacuum assisted drainage until the web has a fiber consistency of about 20% to 30%.

While remaining in contact with the patterned drying fabric, the web is pre-dried by air blow-through pre-dryers to a fiber consistency of about 56% by weight.

After the pre-dryers, the semi-dry web is transferred to the Yankee dryer and adhered to the surface of the Yankee dryer with a sprayed creping adhesive. The creping adhesive is an aqueous dispersion with the actives consisting of about 22% polyvinyl alcohol, about 11% CREPETROL A3025, and about 67% CREPETROL R6390. CREPETROL A3025 and CREPETROL R6390 are commercially available from Hercules Incorporated of Wilmington, Del. The creping adhesive is delivered to the Yankee surface at a rate of about 0.15% adhesive solids based on the dry weight of the web. The fiber consistency is increased to about 97% before the web is dry-creped from the Yankee with a doctor blade.

The doctor blade has a bevel angle of about 25 degrees and is positioned with respect to the Yankee dryer to provide an impact angle of about 81 degrees. The Yankee dryer is operated at a temperature of about 350° F. (177° C.) and a speed of about 750 fpm. The sanitary tissue product is wound in a roll using a surface driven reel drum having a surface speed of about 673 fpm. The sanitary tissue product may be subsequently converted into a one-ply sanitary tissue product.

The sanitary tissue product is then converted into a sanitary tissue product by loading the roll of sanitary tissue product into an unwind stand. The line speed is 800 ft/min. The sanitary tissue product is unwound and transported to a steam header where steam is applied to the sanitary tissue product at a rate of 327-383 g/min. The steam pressure is 29-38 psi and the steam temperature is 270-282° F. The sanitary tissue product is then transported to an emboss stand where the sanitary tissue product is strained to form a surface pattern according to the present invention in the sanitary tissue product. The embossed sanitary tissue product is then transported to a winder where it is wound onto a core to form a log. The log of sanitary tissue product is then transported to a log saw where the log is cut into finished sanitary tissue product rolls. The sanitary tissue product is soft, flexible and absorbent.

### Example 2

A sanitary tissue product in accordance with the present invention is prepared using a sanitary tissue product making machine having a layered headbox having a top chamber, a center chamber, and a bottom chamber. A eucalyptus fiber slurry is pumped through the top headbox chamber, a eucalyptus fiber slurry is pumped through the bottom headbox chamber (i.e. the chamber feeding directly onto the forming wire) and, finally, an NSK fiber slurry is pumped through the center headbox chamber and delivered in superposed relation onto the Fourdrinier wire to form thereon a three-layer embryonic web, of which about 33% of the top side is made up of the eucalyptus blended fibers, 33% is made of the eucalyptus fibers on the bottom side and 33% is made up of the NSK fibers in the center. Dewatering occurs through the Fourdrinier wire and is assisted by a deflector and vacuum boxes. The Fourdrinier wire is of a 5-shed, satin weave configuration having 87 machine-direction and 76 cross-machine-direction monofilaments per inch, respectively. The speed of the Fourdrinier wire is about 750 fpm (feet per minute).

The embryonic wet web is transferred from the Fourdrinier wire, at a fiber consistency of about 15% at the point of transfer, to a patterned drying fabric. The speed of the patterned drying fabric is the same as the speed of the Fourdrinier wire. The drying fabric is designed to yield a pattern of substantially machine direction oriented linear channels having a continuous network of high density (knuckle) areas. This drying fabric is formed by casting an impervious resin surface onto a fiber mesh supporting fabric. The supporting fabric is a 45×52 filament, dual layer mesh. The thickness of the resin cast is about 11 mils above the supporting fabric.

Further de-watering is accomplished by vacuum assisted drainage until the web has a fiber consistency of about 20% to 30%.

While remaining in contact with the patterned drying fabric, the web is pre-dried by air blow-through pre-dryers to a fiber consistency of about 65% by weight.

After the pre-dryers, the semi-dry web is transferred to the Yankee dryer and adhered to the surface of the Yankee dryer with a sprayed creping adhesive. The creping adhesive is an aqueous dispersion with the actives consisting of about 22% polyvinyl alcohol, about 11% CREPETROL A3025, and about 67% CREPETROL R6390. CREPETROL A3025 and CREPETROL R6390 are commercially available from Hercules Incorporated of Wilmington, Del. The creping adhesive is delivered to the Yankee surface at a rate of about 0.15% adhesive solids based on the dry weight of the web. The fiber consistency is increased to about 97% before the web is dry creped from the Yankee with a doctor blade.

The doctor blade has a bevel angle of about 25 degrees and is positioned with respect to the Yankee dryer to provide an impact angle of about 81 degrees. The Yankee dryer is operated at a temperature of about 350° F. (177° C.) and a speed of about 750 fpm. The sanitary tissue product is wound in a roll using a surface driven reel drum having a surface speed of about 656 feet per minute. The sanitary tissue product is subjected to an embossing operation that imparts a surface pattern according to the present invention to a surface of the sanitary tissue product. The sanitary tissue product may be subsequently converted into a two-ply sanitary tissue product having a basis weight of about 39 g/m². For each ply, the outer layer having the eucalyptus fiber furnish is oriented toward the outside in order to form the consumer facing surfaces of the two-ply sanitary tissue product.

The sanitary tissue product is soft, flexible and absorbent.

### Test Methods

Unless otherwise specified, all tests described herein including those described under the Definitions section and the following test methods are conducted on samples that have been conditioned in a conditioned room at a temperature of 73° F.±4° F. (about 23° C.±2.2° C.) and a relative humidity of 50%±10% for 2 hours prior to the test. All plastic and paper board packaging materials must be carefully removed from the paper samples prior to testing Discard any damaged product. All tests are conducted in such conditioned room.

### Basis Weight Test Method

Basis weight of a sanitary tissue product sample is measured by selecting twelve (12) usable units (also referred to as sheets) of the sanitary tissue product and making two stacks of six (6) usable units each. Perforation must be aligned on the same side when stacking the usable units. A precision cutter is used to cut each stack into exactly 8.89 cm×8.89 cm (3.5 in.×3.5 in.) squares. The two stacks of cut squares are combined to make a basis weight pad of twelve (12) squares thick. The basis weight pad is then weighed on a top loading balance with a minimum resolution of 0.01 g. The top loading balance must be protected from air drafts and other disturbances using a draft shield. Weights are recorded when the readings on the top loading balance become constant. The Basis Weight is calculated as follows:

$$Basis Weight ( lbs \text{/} 3000 {ft}^{2} ) = \frac{Weight of basis weight pad ( g ) \times 3000 {ft}^{2}}{\begin{matrix}453.6 g \text{/} lbs \times 12 ( usable units ) \times \\ [ 12.25 {in}^{2} ( Area of basis weight pad ) / 144 {in}^{2} ]\end{matrix}}$$

$$Basis Weight ( g \text{/} {m}^{2} ) = \frac{Weight of basis weight pad ( g ) \times 10 \text{,} 000 {cm}^{2} \text{/} {m}^{2}}{79.0321 {cm}^{2} ( Area of basis weight pad ) \times 12 ( usable units )}$$

### Caliper Test Method

Caliper of a sanitary tissue product is measured by cutting five (5) samples of sanitary tissue product such that each cut sample is larger in size than a load foot loading surface of a VIR Electronic Thickness Tester Model II available from Thwing-Albert Instrument Company, Philadelphia, Pa. Typically, the load foot loading surface has a circular surface area of about 3.14 in². The sample is confined between a horizontal flat surface and the load foot loading surface. The load foot loading surface applies a confining pressure to the sample of 15.5 g/cm². The caliper of each sample is the resulting gap between the flat surface and the load foot loading surface. The caliper is calculated as the average caliper of the five samples. The result is reported in millimeters (mm).

### Elevation Test Method

An elevation of a surface pattern or portion of a surface pattern on a sanitary tissue product, for example an embossment in a sanitary tissue product can be measured using a GFM Mikrocad Optical Profiler instrument commercially available from GFMesstechnik GmbH, Warthestraβe 21, D14513 Teltow/Berlin, Germany. The GFM Mikrocad Optical Profiler instrument includes a compact optical measuring sensor based on the digital micro mirror projection, consisting of the following main components: a) DMD projector with 1024×768 direct digital controlled micro mirrors, b) CCD camera with high resolution (1300×1000 pixels), c) projection optics adapted to a measuring area of at least 44 mm×33 mm, and d) matching resolution recording optics; a table tripod based on a small hard stone plate; a cold light source; a measuring, control, and evaluation computer; measuring, control, and evaluation software ODSCAD 4.0, English version; and adjusting probes for lateral (x-y) and vertical (z) calibration.

The GFM Mikrocad Optical Profiler system measures the surface height of a sanitary tissue product sample using the digital micro-mirror pattern projection technique. The result of the analysis is a map of surface height (z) vs. xy displacement. The system has a field of view of 48×36 mm with a resolution of 29 microns. The height resolution should be set to between 0.10 and 1.00 micron. The height range is 64,000 times the resolution.

To measure the height or elevation of a surface pattern or portion of a surface pattern on a surface of a sanitary tissue product, the following can be performed: (1) Turn on the cold light source. The settings on the cold light source should be 4 and C, which should give a reading of 3000K on the display; (2) Turn on the computer, monitor and printer and open the ODSCAD 4.0 or higher Mikrocad Software; (3) Select “Measurement” icon from the Mikrocad taskbar and then click the “Live Pic” button; (4) Place a sanitary tissue product sample, of at least 5 cm by 5 cm in size, under the projection head and adjust the distance for best focus; (5) Click the “Pattern” button repeatedly to project one of several focusing patterns to aid in achieving the best focus (the software cross hair should align with the projected cross hair when optimal focus is achieved). Position the projection head to be normal to the sanitary tissue product sample surface; (6) Adjust image brightness by changing the aperture on the camera lens and/or altering the camera “gain” setting on the screen. Set the gain to the lowest practical level while maintaining optimum brightness so as to limit the amount of electronic noise. When the illumination is optimum, the red circle at bottom of the screen labeled “I.O.” will turn green; (7) Select Standard measurement type; (8) Click on the “Measure” button. This will freeze the live image on the screen and, simultaneously, the surface capture process will begin. It is important to keep the sample still during this time to avoid blurring of the captured images. The full digitized surface data set will be captured in approximately 20 seconds; (9) Save the data to a computer file with “.omc” extension. This will also save the camera image file “.kam”; (10) Export the file to the FD3 v1.0 format; 11) Measure and record at least three areas from each sample; 12) Import each file into the software package SPIP (Image Metrology, A/S, Hørsholm, Denmark); 13) Using the Averaging profile tool, draw a profile line perpendicular to height or elevation (such as embossment) transition region. Expand the averaging box to include as much of the height or elevation (embossment) as practical so as to generate and average profile of the transition region (from top surface to the bottom of the surface pattern or portion of surface pattern (such as an embossment) and backup to the top surface.). In the average line profile window, select a pair of cursor points.

To move the surface data into the analysis portion of the software, click on the clipboard/man icon; (11) Now, click on the icon “Draw Lines”. Draw a line through the center of a region of features defining the texture of interest. Click on Show Sectional Line icon. In the sectional plot, click on any two points of interest, for example, a peak and the baseline, then click on vertical distance tool to measure height in microns or click on adjacent peaks and use the horizontal distance tool to determine in-plane direction spacing; and (12) for height measurements, use 3 lines, with at least 5 measurements per line, discarding the high and low values for each line, and determining the mean of the remaining 9 values. Also record the standard deviation, maximum, and minimum. For x and/or y direction measurements, determine the mean of 7 measurements. Also record the standard deviation, maximum, and minimum. Criteria that can be used to characterize and distinguish texture include, but are not limited to, occluded area (i.e. area of features), open area (area absent of features), spacing, in-plane size, and height. If the probability that the difference between the two means of texture characterization is caused by chance is less than 10%, the textures can be considered to differ from one another.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A sanitary tissue product having a surface exhibiting a machine direction and a cross machine direction, wherein the surface comprises a surface pattern comprising a filamentary pattern overlaying a filamentary line pattern.

2. The sanitary tissue product according to claim 1 wherein the filamentary pattern comprises a motif comprising a dot.

3. The sanitary tissue product according to claim 2 wherein the motif comprises a plurality of dots.

4. The sanitary tissue product according to claim 3 wherein the plurality of dots create a dot pattern.

5. The sanitary tissue product according to claim 1 wherein the filamentary pattern comprises two or more motifs that are spaced apart from one another center-to-center by at least 1.5 cm.

6. The sanitary tissue product according to claim 1 wherein the surface pattern comprises two or more filamentary patterns.

7. The sanitary tissue product according to claim 6 wherein at least one of the two or more filamentary patterns comprises a motif comprising a dot.

8. The sanitary tissue product according to claim 6 wherein at least two of the two or more filamentary patterns are spaced apart from one another center-to-center by at least 1 cm.

9. The sanitary tissue product according to claim 1 wherein the filamentary pattern is formed by two continuous lines.

10. The sanitary tissue product according to claim 9 wherein at least one of the two continuous lines exhibits a minimum width of at least 10 mils.

11. The sanitary tissue product according to claim 1 wherein the filamentary pattern is formed by at least one broken line.

12. The sanitary tissue product according to claim 1 wherein the filamentary pattern exhibits a minimum width of at least 40 mils.

13. The sanitary tissue product according to claim 1 wherein the surface pattern comprises two or more filamentary line patterns.

14. The sanitary tissue product according to claim 13 wherein at least two of the two or more filamentary line patterns are spaced apart from one another center-to-center by at least 2 mm.

15. The sanitary tissue product according to claim 1 wherein the filamentary line pattern is formed by two continuous lines.

16. The sanitary tissue product according to claim 15 wherein at least one of the two continuous lines exhibits a minimum width of at least 10 mils.

17. The sanitary tissue product according to claim 1 wherein the filamentary line pattern is formed by at least one broken line.

18. The sanitary tissue product according to claim 1 wherein the filamentary line pattern exhibits a minimum width of at least 40 mils.

19. The sanitary tissue product according to claim 1 wherein the filamentary pattern overlays the filamentary line pattern at an angle of from about 20° to about 160°.

20. The sanitary tissue product according to claim 19 wherein the filamentary pattern overlays the filamentary line pattern at an angle of about 90°.

21. The sanitary tissue product according to claim 1 wherein the filamentary pattern is oriented on the surface of the sanitary tissue product at an angle of from about 20° to about 160° relative to the machine direction.

22. The sanitary tissue product according to claim 21 wherein the filamentary pattern is oriented on the surface of the sanitary tissue product at an angle of about 45° relative to the machine direction.

23. The sanitary tissue product according to claim 1 wherein the filamentary line pattern is oriented on the surface of the sanitary tissue product at an angle of from about 20° to about 160° relative to the machine direction.

24. The sanitary tissue product according to claim 23 wherein the filamentary line pattern is oriented on the surface of the sanitary tissue product at an angle of about 45° relative to the machine direction.

25. The sanitary tissue product according to claim 1 wherein the surface pattern further comprises a second filamentary line pattern.

26. The sanitary tissue product according to claim 25 wherein the second filamentary line pattern is present in the filamentary pattern.

27. The sanitary tissue product according to claim 25 wherein the second filamentary line pattern is present in the filamentary line pattern.

28. The sanitary tissue product according to claim 25 wherein the surface pattern comprises two or more second filamentary line patterns.

29. The sanitary tissue product according to claim 28 wherein at least two of the two or more second filamentary line patterns are spaced apart from one another center-to-center by at least 1 mm.

30. The sanitary tissue product according to claim 25 wherein the second filamentary line pattern is formed by two continuous lines.

31. The sanitary tissue product according to claim 30 wherein at least one of the two continuous lines exhibits a minimum width of at least 3 mils.

32. The sanitary tissue product according to claim 25 wherein the second filamentary line pattern is formed by at least one broken line.

33. The sanitary tissue product according to claim 1 wherein the second filamentary line pattern exhibits a minimum width of at least 0.5 mils.

34. The sanitary tissue product according to claim 25 wherein the filamentary pattern intersects the second filamentary line pattern at an angle of from about 20° to about 160°.

35. The sanitary tissue product according to claim 34 wherein the filamentary pattern intersects the second filamentary line pattern at an angle of about 90°.

36. The sanitary tissue product according to claim 25 wherein the second filamentary line pattern is oriented on the surface of the sanitary tissue product at an angle of from about 0° to about 15° relative to the machine direction.

37. A sanitary tissue product comprising a surface comprising a surface pattern having a continuous element that extends across the surface in a first direction and a discrete element that extends across the surface in a second direction, wherein the second direction intersects the first direction.

38. The sanitary tissue product according to claim 1 wherein the surface pattern further comprises a discrete motif pattern comprising two or more discrete individual motifs.

39. A sanitary tissue product having a surface comprising a surface pattern comprising a filamentary pattern overlaying a filamentary line pattern and further comprising a discrete motif pattern comprising two or more discrete individual motifs.
